(19) United States
(12) Patent Application Publication
(10) Pub. No.: US 2026/0202947 A1
(43) Pub. Date: Jul. 16, 2026

(54) DISPLAY CONTROL DEVICE, DISPLAY CONTROL METHOD, AND STORAGE MEDIUM

(71) Applicant: TOYOTA JIDOSHA KABUSHIKI KAISHA, Toyota-shi Aichi-ken (JP)

(72) Inventor: Satoshi Naito, Yokohama-shi Kanagawa-ken (JP)

(73) Assignee: TOYOTA JIDOSHA KABUSHIKI KAISHA, Toyota-shi Aichi-ken (JP)

(21) Appl. No.: 19/446,334

(22) Filed: Jan. 12, 2026

(30) Foreign Application Priority Data
Jan. 15, 2025 (JP) 2025-005465

(51) Int. Cl. G06F 3/0484; G06F 3/04817

(52) U.S. Cl. CPC G06F 3/0484; G06F 3/04817

(57) ABSTRACT

Short cut buttons are displayed on a basic screen of a display device. A plurality of candidates for functions to be assigned to the short cut buttons are made to be displayed on a function selection screen of the display device and a user is made to select functions to be assigned to the short cut buttons. When acquiring addition information of new functions or update information of existing functions, the added new functions or the updated existing functions are preferentially displayed as candidates of functions on the function selection screen.

### CROSS-REFERENCE TO RELATED APPLICATIONS

This application claims priority to Japanese Patent Application No. 2025-005465 filed January 15, 2025, the entire contents of which are herein incorporated by reference.

### FIELD

The present disclosure relates to a display control device, display control method, and storage medium.

### BACKGROUND

Known in the art is an information apparatus designed to display vehicle function buttons, that is, short cut buttons, for calling up specific functions relating to operation of a vehicle, on a menu screen of a display device mounted in the vehicle (for example, see Japanese Unexamined Patent Publication No. 2024-49711). This information apparatus is designed to acquire the frequencies of use of the different functions relating to operation of the vehicle separated into use while the vehicle is moving and while the vehicle is stopped, display function buttons, that is, short cut buttons, for calling up functions judged to be high in frequency of use while the vehicle was moving when the vehicle is moving, and display function buttons, that is, short cut buttons, for calling up functions judged to be high in frequency of use while the vehicle was stopped when the vehicle is stopped.

### SUMMARY

In this regard, in recent years, in automobiles, the work of updating software for control of various functions by wireless communications and adding new functions or updating existing functions are frequently performed. In this case, among the users, there are users who wish to immediately actively use these added new fundtions or updated existing functions. For such users, it can be said to be desirable to be able to immediately display short cut buttons for these added new functions or updated existing functions without causing the user to feel burdened. On the other hand, in the above-mentioned information apparatus, the short cut buttons are displayed, but the short cut buttons are displayed for functions with high frequencies of use, so if the history of use of a function has not been built up to a certain extent, the short cut button will not be displayed. Therefore, there is the problem that a user has to repeatedly perform the burdersome operation for display of the short cut button until the history of use of a function has been built up to a certain extent.

The present disclosure is designed to enable the work of displaying short cut buttons, that is, the work of assigning the added new functions or the updated existing functions to the short cut buttons, to be able to be performed without the user feeling that burdened.

According to the present disclosure, there is provided a display control device for controlling a screen display of a display device mounted in a vehicle, the display control device comprising:

a short cut button display control unit for making short cut buttons be displayed on a basic screen of the display device and

a function assigning unit for making a plurality of candidates for functions to be assigned to the short cut buttons be displayed on a function selection screen of the display device and making a user select functions to be assigned to the short cut buttons,

the function assigning unit making added new functions or updated existing functions be preferentially displayed as the candidates of functions on the function selection screen when acquiring addition information of the new functions or update information of the existing functions.

Furthermore, according to the present disclosure, there is provided a display control method for controlling a screen display of a display device mounted in a vehicle, the display control method causing a computer to

make short cut buttons be displayed on a basic screen of the display device,

make a plurality of candidates for functions to be assigned to the short cut buttons be displayed on a function selection screen of the display device and make a user select functions to be assigned to the short cut buttons, and,

make added new functions or updated existing functions be preferentially displayed as the candidates of functions on the function selection screen when acquiring addition information of the new functions or update information of the existing functions.

Furthermore, according to the present disclosure, there is provided a storage medium storing a program used for controlling a screen display of a display device mounted in a vehicle, the program causing a computer to

make short cut buttons be displayed on a basic screen of the display device,

make a plurality of candidates for functions to be assigned to the short cut buttons be displayed on a function selection screen of the display device and make a user select functions to be assigned to the short cut buttons, and,

make added new functions or updated existing functions be preferentially displayed as the candidates of functions on the function selection screen when acquiring addition information of the new functions or update information of the existing functions.

A user can perform the work of assigning the added new functions and the updated existing functions to the short cut buttons without causing the user to feel that burdened.

### BRIEF DESCRIPTION OF DRAWINGS

FIG. 1 is a top view of a vehicle shown schematically.

FIG. 2 is a view showing a functional configuration of a vehicle.

FIG. 3A is a view schematically showing a basic screen of a display device.

FIG. 3B is a view schematically showing a basic screen of a display device.

FIG. 4A is a view schematically showing a screen of a display device.

FIG. 4B is a view schematically showing a screen of a display device.

FIG. 5A is a view schematically showing a screen of a display device.

FIG. 5B is a view schematically showing a screen of a display device.

FIG. 6A is a view schematically showing a screen of a display device.

FIG. 6B is a view schematically showing a screen of a display device.

FIG. 7A is a view schematically showing a screen of a display device.

FIG. 7B is a view schematically showing a screen of a display device.

FIG. 8 is a view schematically showing a screen of a display device.

FIG. 9 is a view schematically showing a screen of a display device.

FIG. 10 is a view schematically showing a screen of a display device.

FIG. 11 is a view schematically showing a basic screens of a display device.

FIG. 12 is a flow chart for performing processing for setting functions on/off without using short cut buttons.

FIG. 13 is a flow chart for performing processing for setting functions on/off by using short cut buttons.

FIG. 14 is a flow chart for performing processing for receiving the addition/update information of functions.

FIG. 15 is a flow chart for performing the processing for display of the added/updated functions.

FIG. 16 is a flow chart for performing processing for assigning functions to the short cut buttons.

### DESCRIPTION OF EMBODIMENTS

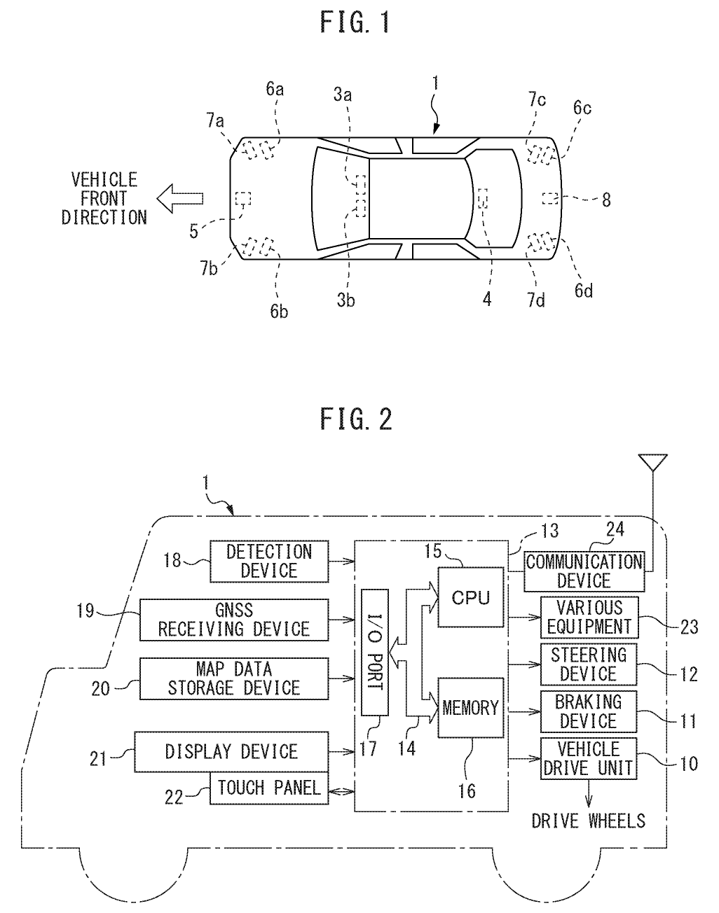

FIG. 1 schematically shows a vehicle 1 when viewed from above, while FIG. 2 shows the functional configuration of the vehicle 1 shown in FIG. 1. Note that, this vehicle 1 can be driven by either manual driving and autonomous driving. If referring to FIG. 2, 10 indicates a vehicle drive unit for imparting drive force to drive wheels of the vehicle 1, 11 indicates a braking device for braking the vehicle 1, 12 indicates a steering device for steering the vehicle 1, and 13 indicates an electronic control unit mounted in the vehicle 1. As shown in FIG. 2, the electronic control unit 13 is comprised of a digital computer and is provided with a CPU (processor) 15, a memory 16 comprised of a ROM and RAM, and an input/output port 17 which are connected with each other by a bidirectional bus 14.

On the other hand, as shown in FIG. 2, in the vehicle 1 , a detection device 18 including various types of sensors required when the vehicle 1 is being manually driven or automatically driven is arranged. This detection device 18 includes sensors for detecting the state of the vehicle 1 and sensors for detecting the surroundings of the vehicle 1. In this case, as sensors for detecting the state of the vehicle 1, an acceleration sensor, speed sensor, azimuth sensor, and geomagnetic sensor are used. As sensors for detecting the surroundings of the vehicle 1, cameras for capturing the areas in front of, at the sides of, and at the back of the vehicle 1, and lidars, radars, clearance sonars, etc. for detecting the areas in front of, at the sides of, and at the back of the vehicle 1 are used.

FIG. 1 shows one example of the sensors arranged in the vehicle 1. In the example shown in FIG. 1, visible light cameras 3a, 3b for capturing the area in front of the vehicle 1, a rear camera 4 for capturing the area in back of the vehicle 1, a long distance millimeter wave radar 5 for emitting millimeter waves toward the area in front of the vehicle 1, medium distance millimeter wave radars 6a, 6b, 6c, and 6d for emitting millimeter waves toward the areas at the sides of the vehicle 1, lidars 7a, 7b, 7c, and 7d for firing laser beams toward the areas at the sides of the vehicle 1, and clearance sonar 8 for emitting ultrasonic waves toward the area in back of the vehicle 1 are arranged in the vehicle 1. Note that, the method of setting the cameras and sensors shown in FIG. 1 shown is just an example. There are various methods for arranging these cameras and sensors.

Returning again to FIG. 2, the vehicle 1 is provided with a GNSS (global navigation satellite system) receiving device 19, map data storage device 20, and display device 21. The GNSS receiving device 19 can detect a current position of the vehicle 1 (for example, the latitude and longitude of the vehicle 1) based on information obtained from a plurality of artificial satellites. Therefore, it is possible to acquire the current position of the vehicle 1 by this GNSS receiving device 19. As this GNSS receiving device 19, for example, a GPS receiving device is used. Further, in the map data storage device 20, the map data etc. necessary for the vehicle 1 to run is stored. The detection device 18, the GNSS receiving device 19, and the map data storage device 20 are connected to the electronic control unit 13.

The display device 21 is arranged inside the vehicle compartment and has a screen able to be viewed by the user of the vehicle 1, for example, the driver of the vehicle 1. A pressure sensitive type, electrostatic inductance type, or electrostatic capacity type thin film shaped touch panel 22 is integrally formed on the screen of the display device 21. These display device 21 and touch panel 22 are connected to the electronic control unit 13. Further, headlights, turn lights, inside compartment lights, an air-conditioner, and other various devices 23 are arranged in the vehicle 1. These various devices 23 are connected to the electronic control unit 13. A communication device 24 for receiving television broadcasts, radio broadcasts, traffic information, etc. and trading signals with information centers or other vehicles is mounted in the vehicle 1. This communication device 24 is connected to the electronic control unit 13.

In the example shown in FIG. 2, the vehicle drive unit 10 of the vehicle 1 is comprised of an electric motor driven by a secondary battery or an electric motor driven by a fuel cell. The drive wheels are controlled in drive by these electric motors in accordance with output signals of the electronic control unit 13. Further, the braking of the vehicle 1 is controlled by the braking device 11 in accordance with output signals of the electronic control unit 13, while the steering of the vehicle 1 is controlled by the steering device 12 in accordance with output signals of the electronic control unit 13.

First, the meanings of the terms used in this Description will be simply explained.

In this Description, “power on” indicates “a state where the vehicle 1 can be controlled in drive” while “power off” indicates “a state where the vehicle 1 cannot be controlled in drive”.

Further, in this Description, “function on” indicates “a state where a function is activated or a state where a function can be activated” while “function off” indicates “a state where a function is deactivated”.

Further, in this Description, “a function is set on” indicates “a function is set so that the function is activated” while “a function is set off” indicates “a function is set so that the function is deactivated”.

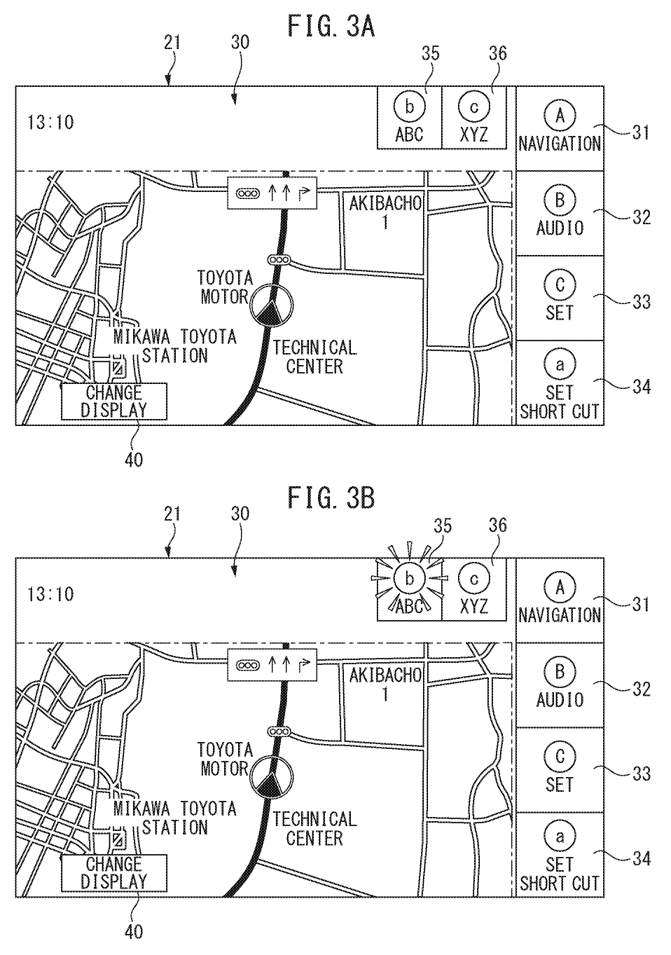

Next, referring to FIG. 3A, the screen 30 of the display device 21 used in an embodiment according to the present disclosure will be explained. If the display device 21 is started up, as shown in FIG. 3A, a button 31 for a navigation function which is one of the basic functions, a button 32 for an audio function which is one of the basic functions, and a button 33 for a setting function which is one of the basic functions are displayed on the surroundings of the screen 30 of the display device 21. At this time, as shown in FIG. 3A, for example, a road map is displayed on the screen 30 of the display device 21. In this Description, the screen 30 on which the button 31 for a navigation function which is one of the basic functions, the button 32 for an audio function which is one of the basic functions, and the button 33 for a setting function which is one of the basic functions are displayed like when the display device 21 is started up will be called a “basic screen”.

Note that, in the embodiment shown in FIG. 3A, a layer of the thin film shaped touch panel 22 is formed on the screen 30 of the display device 21. In FIG. 3A, if buttons displayed on the screen 30 such as the navigation function button 31, audio function button 32, and setting function button 33 are touched, the fact of the buttons being touched is recognized by the electronic control unit 13 through the touch panel 22. In this Description, the fact of buttons being displayed on the screen 30 so that the fact of buttons being touched is recognized by the electronic control unit 13 will be referred to simply as the buttons being displayed on the screen 30. Note that, in FIG. 3A, the marks A, B, C and letters illustrate schematically icons showing the navigation function, audio function, and setting function.

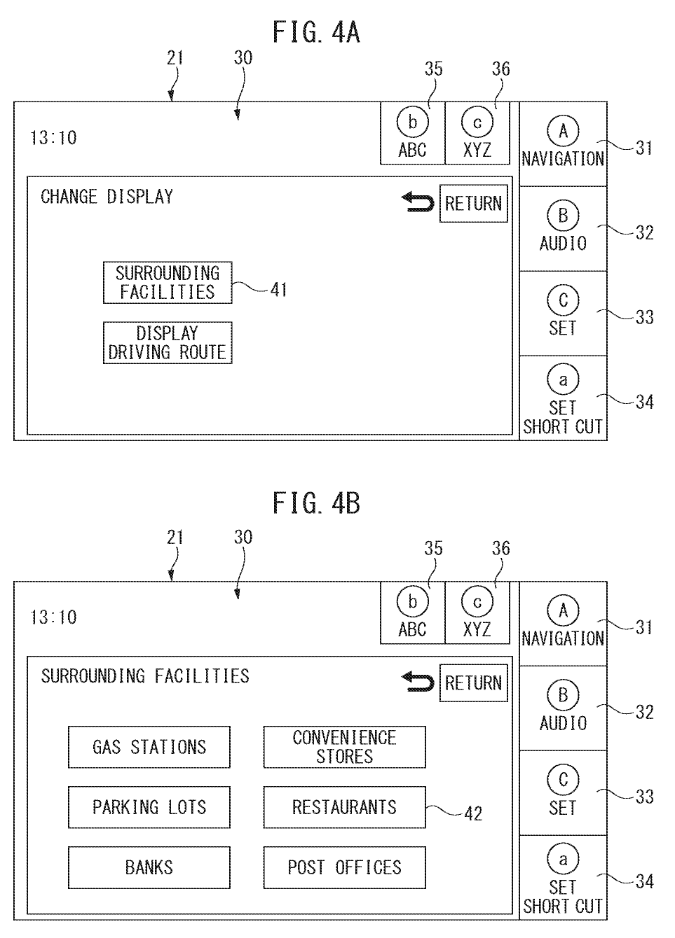

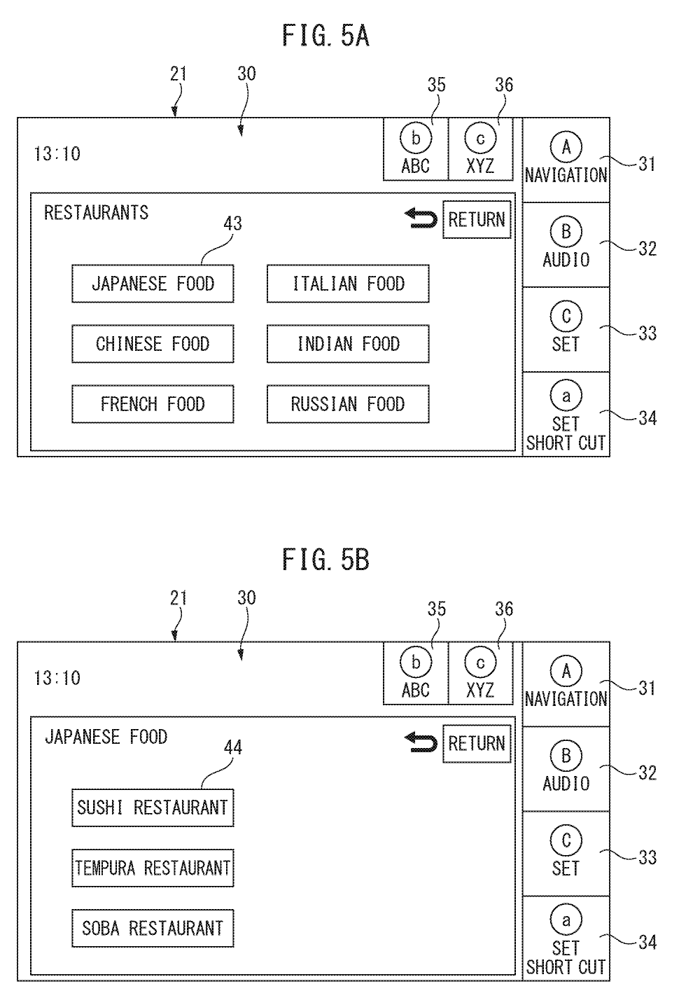

Next, one example of the button operation in these basic functions will be simply explained. FIG. 3A shows the case where the button 31 for a navigation function is touched and a road map is displayed on the basic screen of the display device 21. If a display changing button 40 provided on this road map is touched, the road map is switched to a display changing screen such as shown in FIG. 4A positioned one level lower. Next, if, for example, a surrounding facility button 41 which is displayed on this display changing screen is touched, the display changing screen is switched to a surrounding facility selection screen such as shown in FIG. 4B positioned one level lower. Next, if, for example, a restaurant button 42 which is displayed on this surrounding facility selection screen is touched, the surrounding facility selection screen is switched to a restaurant selection screen such as shown in FIG. 5A positioned a further one level lower. Next, if for example a Japanese food button 43 displayed on this restaurant selection screen is touched, the restaurant selection screen is switched to a Japanese food selection screen such as shown in FIG. 5B positioned a still further one level lower. Next, if for example a sushi restaurant button 44 displayed on this Japanese food selection screen is touched, the Japanese food selection screen is switched to the road map screen shown in FIG. 3A and the positions of sushi restaurants are displayed on the road map.

In this way, in this example, by the sushi restaurant button 44 positioned at a deep level being touched, the sushi restaurant display function for displaying the positions of sushi restaurants on the road map is set on, the sushi restaurant position display function is activated, and the positions of sushi restaurants are displayed on the road map. In this case, when for example the positions of sushi restaurants are displayed on the road map, if the button 31 for navigation function use is touched, the sushi restaurant position display function is set off and the display of the positions of the sushi restaurants disappears from this road map. Note that a plurality of other buttons are usually displayed on the road map, the display changing screen, the surrounding facility selection screen, the restaurant selection screen, and the Japanese food selection screen respectively shown in FIG. 3A, FIG. 4A, FIG. 4B, FIG. 5A, and FIG. 5B, but in FIG. 3A, FIG. 4A, FIG. 4B, FIG. 5A, and FIG. 5B , display of these plurality of other buttons is omitted.

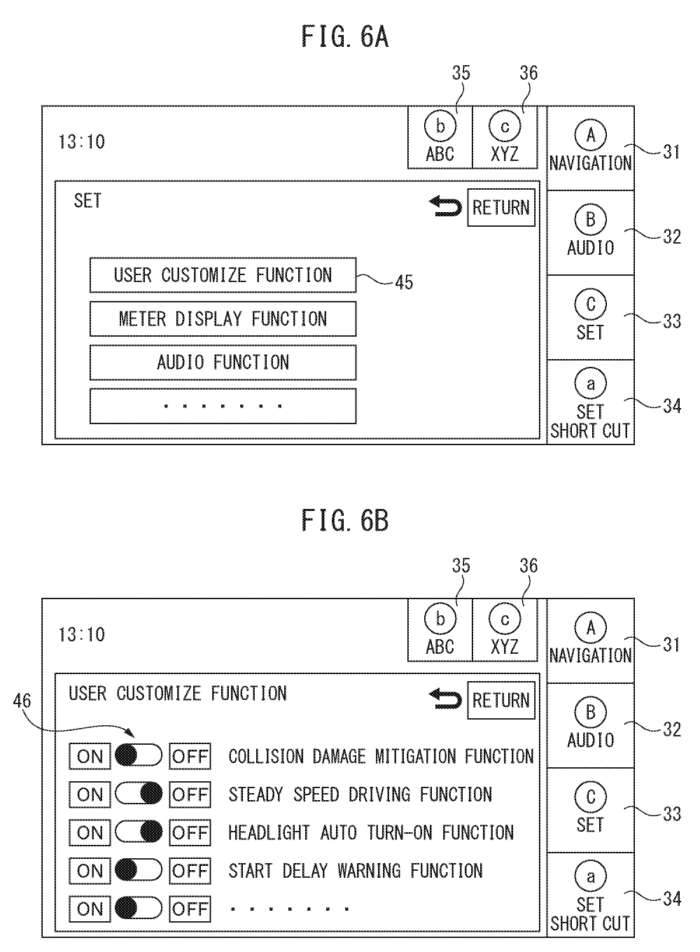

On the other hand, when, for example, the road map is displayed on the basic screen of the display device 21 such as shown in FIG. 3A, if the setting button 33 is touched, the road map is switched to a setting screen such as shown in FIG. 6A positioned one level lower. Next, if, for example, a user customize function button 45 displayed on this setting screen is touched, the setting screen is switched to a user customize function selection screen such as shown in FIG. 6B positioned one further level lower. In the example shown in FIG. 6B, an on-off display 46 is displayed on the user customize function selection screen for showing whether respective functions are currently on or off.

Here, if simply explaining the functions displayed on the user customize function selection screen, a collision damage mitigating function is a function of using the braking device 11 to impart a braking force to the vehicle 1 when a state where the vehicle 1 approaches another vehicle from the rear is detected by the detection device 18, a steady speed running function is a function of making the vehicle 1 run at a steady speed which is set, a headlight auto turn-on function is a function of automatically turning on the headlights when the brightness of the surroundings becomes a threshold value or less, and a start delay warning function is a function of issuing a warning when for example the vehicle 1 continues to be stopped despite another vehicle stopped in front of the vehicle 1 starting to move. Note that, in FIG. 6A and FIG. 6B, the expression “…….” means there is a description, but details of the description are omitted. The same is true below.

That is, the functions described in FIG. 6B are just part of the functions listed on the user customize function selection screen. In actuality, the user customize function selection screen displays a far greater number of functions. In FIG. 6B, for example, if focusing on the headlight auto turn-on function, currently the headlight auto turn-on function is deactivated as will be understood from the on/off display 46. That is, the headlight auto turn-on function is set off. In this case, if touching the ON button of the headlight auto turn-on function, the headlight auto turn-on function changes from the off setting to the on setting and the on/off display 46 changes to show an on setting. In this way, in this example, by touching the corresponding button on the user customize function selection screen positioned at the deepest level, it is possible to switch all of the functions from the off setting to the on setting or switch them from the on setting to the off setting.

In this way, the buttons for setting functions on or setting them off are positioned at the deep level. However, in this way, if buttons are positioned at the deep level, time is taken for operating the buttons. In particular, if buttons of functions often utilized by a user are positioned at the deep level, for the user, operation of the button becomes considerably burdensome. Therefore, to lighten the burden on the user, in an embodiment according to the present disclosure, as shown in FIG. 3A, two short cut buttons 35, 36 for operation to which respectively different functions are assigned are displayed on the basic screen of the display device 21. Of course, three or more of such short cut buttons can also be displayed, but below, an embodiment according to the present disclosure will be explained with reference to an example of a case where two short cut buttons 35, 36 are displayed. Note that, in FIG. 3A, the marks “b”, “c” and letters ABC, XYZ schematically show icons.

In an embodiment according to the present disclosure, if touching the short cut button 35, when the function assigned to the short cut button 35 is currently set off, it is switched to an on setting. Due to this, the function assigned to the short cut button 35 is activated. Next, if touching the short cut button 35 one more time, the function assigned to the short cut button 35 is switched from the on setting to the off setting whereupon the function assigned to the short cut button 35 is deactivated. That is, each time touching the short cut button 35, the on setting and off setting of the function are switched whereupon activation of the function and deactivation of the function are switched.

Similarly, if touching the short cut button 36, when the function assigned to the short cut button 36 is currently set off, it is switched to an on setting. Due to this, the function assigned to the short cut button 36 is activated. Next, if touching the short cut button 36 one more time, the function assigned to the short cut button 36 is switched from the on setting to the off setting whereupon the function assigned to the short cut button 36 is deactivated. That is, each time touching the short cut button 36, the on setting and off setting of the function are switched whereupon activation of the function and deactivation of the function are switched.

Further, in an embodiment according to the present disclosure, if touching the short cut button 35, when the function assigned to the short cut button 35 is set off, the short cut button 35 is rendered off in display, while if the function assigned to the short cut button 35 is set on, the short cut button 35 is rendered on in display. Similarly, when the function assigned to the short cut button 36 is set off, the short cut button 36 is rendered off in display, while if the function assigned to the short cut button 36 is set on, the short cut button 36 is rendered on in display.

An example when the short cut button 35 is rendered off in display and when the short cut button 35 is rendered on in display is shown in FIG. 3A and FIG. 3B. In this example, when the short cut button 35 is the same brightness as the other buttons 31, 32, and 33 as shown in FIG. 3A, the display of the short cut button 35 is deemed off in display while when the short cut button 35 as a whole shines brightly or when the icon part of the short cut button 35 shines brightly as shown in FIG. 3B, the short cut button 35 is deemed on in display. Similarly, when the short cut button 36 is the same brightness as the other buttons 31, 32, and 33, the short cut button 36 is deemed off in display, while when the short cut button 36 as a whole shines brightly or when the icon part of the short cut button 36 shines brightly, the short cut button 36 is deemed on in display.

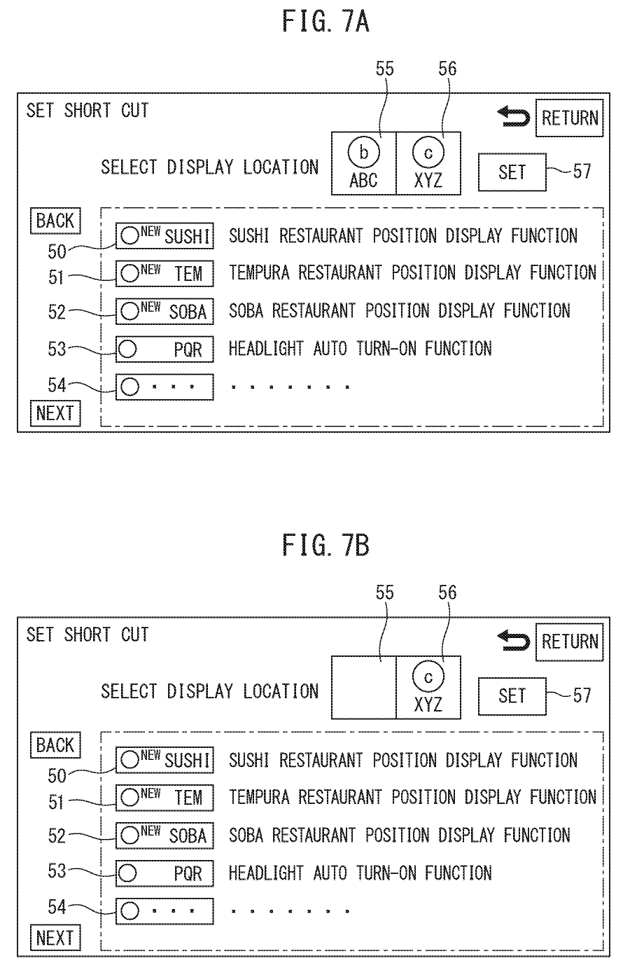

Further, in an embodiment according to the present disclosure, to assign functions to the short cut buttons 35, 36, as shown in FIG. 3A and FIG. 3B, a short cut setting button 34 is displayed on the basic screen of the display device 21. In this case, for example, if the short cut setting button 34 is touched when the road map is displayed on the basic screen of the display device 21 as shown in FIG. 3A, the road map is switched to a short cut setting screen positioned at one lower level such as shown in FIG. 7A. In the example shown in FIG. 7A, candidates of functions able to be assigned to the short cut buttons 35, 36 are displayed on the short cut setting screen. Furthermore, for the candidates of the functions displayed, the short cut setting buttons 50, 51, 52, 53, and 54 are respectively displayed. Icons comprised of marks and letters are displayed on the short cut setting buttons 50, 51, 52, 53, and 54.

Note that, the candidates of the functions shown in FIG. 7A, that is, the sushi restaurant position display function, the tempura restaurant position display function, the soba restaurant position display function and the headlight auto turn-on function, are just some of the candidates of functions listed on the short cut setting screen. In actuality, a far greater number of the candidates of functions are displayed on the short cut setting screen. In this case, in the example shown in FIG. 7A, numerous candidates of functions are displayed over several pages. Further, in the example shown in FIG. 7A, the short cut setting buttons 50, 51, 52, 53, 54 of the candidates of functions which are set on, that is, the candidates of the functions which are activated are rendered on in display, while the short cut setting buttons 50, 51, 52, 53, 54 of the candidates of functions which are set on shine brightly at the short cut setting buttons 50, 51, 52, 53, 54 as a whole or the icon parts. The functions to be assigned to the short cut buttons 35, 36 displayed on the basic screen of the display device 21 are selected by the user of the vehicle 1 from among the candidates of functions listed on this short cut setting screen.

Further, in the example shown in FIG. 7A, display location selection buttons 55 and 56 for selecting one of the two short cut buttons 35, 36 displayed on the basic screen of the display device 21 to which the function selected by the user of the vehicle 1 should be assigned are displayed on the short cut setting screen. In this case, the display location selection buttons 55 and 56 are provided so that it is understood that the short cut button 35 displayed on the basic screen of the display device 21 corresponds to the display location selection button 55 displayed on the short cut setting screen while the short cut button 36 displayed on the basic screen of the display device 21 corresponds to the display location selection button 56 displayed on the short cut setting screen. In this case, in the example shown in FIG. 7A, the short cut button 35 and the display location selection button 55 are displayed by the same icon while the short cut button 36 and the display location selection button 56 are displayed by the same icon. In this case, if no function is assigned to, for example, the short cut button 35, as will be understood from FIG. 7B, no icon is displayed at the display location selection button 55.

For example, when the user of the vehicle 1 desires to assign the sushi restaurant position display function to the short cut button 35, if the user touches the short cut setting button 50 of the sushi restaurant position display function, then touches the display location selection button 55, then touches the setting button 57, the sushi restaurant position display function is assigned to the short cut button 35. If the sushi restaurant position display function is assigned to the short cut button 35, the display and icon of the function which had been assigned to the short cut button 35 up to then are returned to the short cut setting screen and an icon showing the sushi restaurant position display function is displayed on the short cut button 35. If the sushi restaurant position display function finishes being assigned to the short cut button 35, after that, it becomes possible to switch between the on setting and off setting of the sushi restaurant position display function by just touching the short cut button 35 displayed on the basic screen of the display device 21.

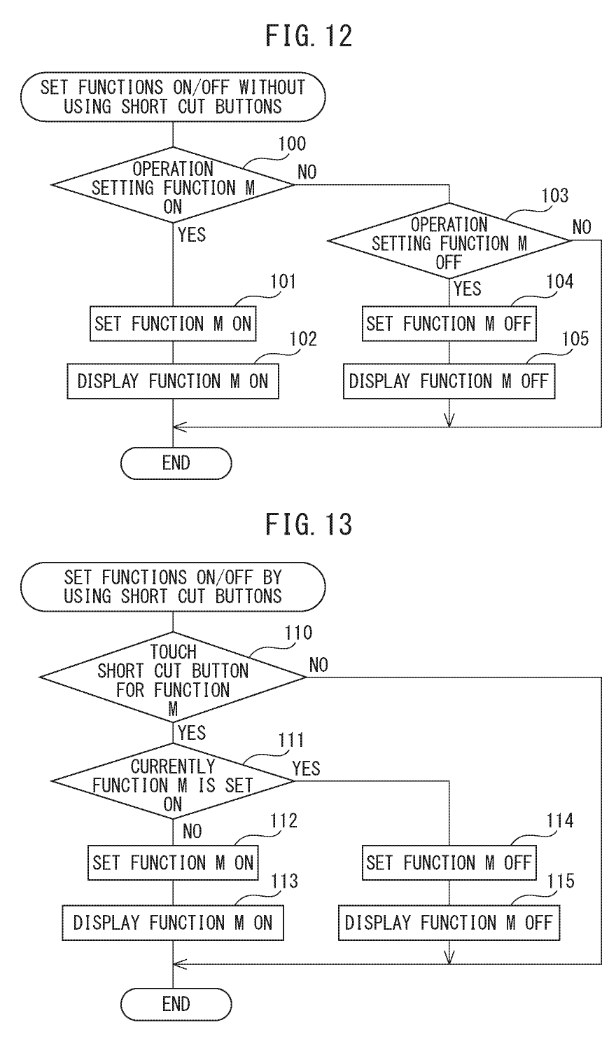

Next, referring to FIG. 12 and FIG. 13, the routine for performing processing for setting functions on/off without using the short cut buttons 35, 36 and the routine for performing processing for setting functions on/off by using the short cut buttons 35, 36 will be successively explained. FIG. 12 shows a flow chart for performing processing for setting functions on/off without using short cut buttons 35, 36, and FIG. 13 shows a flow chart for performing processing for setting functions on/off by using short cut buttons 35, 36. The routines shown in FIG. 12 and FIG. 13 are provided for each function and these routines are repeatedly performed in the electronic control unit 13. Note that, a program for performing each function is stored in advance in the memory 16 of the electronic control unit 13.

Referring to FIG. 12 showing the routine for performing the processing for setting functions on/off without using the short cut buttons 35, 36, first, at step 100, it is judged whether an operation requesting activation of the function M, that is, an operation for setting the function M on has been performed by the user. For example, when the user touches the sushi restaurant button 44 in FIG. 5B, it is judged that an operation requesting activation of the sushi restaurant position display function for displaying positions of sushi restaurants on the road map has been performed, that is, an operation for setting the sushi restaurant position display function on has been performed. In this case, the function M indicates the sushi restaurant position display function. Further, when the user touches the ON button of the headlight auto turn-on function in FIG. 6B, it is judged that an operation requesting activation of the headlight auto turn-on function for making the headlights automatically turn on when the brightness of the surroundings becomes a threshold value or less has been performed, that is, an operation for setting the headlight auto turn-on function on has been performed. In this case, the function M indicates the headlight auto turn-on function.

When, at step 100, it is judged that an operation requesting activation of the function M, that is, an operation for setting the function M on has been performed by the user, the routine proceeds to step 101 where the function M is set on and the function M is activated. At this time, if the function M is the sushi restaurant position display function, the sushi restaurant position display function for displaying positions of sushi restaurants on the road map is performed, while if the function M is the headlight auto turn-on function, the headlight auto turn-on function for making the headlights automatically turn on is performed. If the function M is set on, as shown at step 102, the function M is rendered on in display. At this time, the on/off display switch 46 of the function M shown in FIG. 6B is switched from “display off” to “display on” while the short cut setting button of the candidates of the function M shown in FIG. 7A etc. is switched from “display off” to “display on”. If the short cut button for the function M is being displayed, the short cut button for the function M is switched from an “display off” to “display on”.

As opposed to this, when at step 100, it is judged that an operation requesting activation of the function M, that is, an operation for setting the function M on has not been performed by the user, the routine proceeds to step 103 where it is judged whether an operation for deactivation of the function M, that is, an operation for setting the function M off has been performed by the user. For example, when the positions of sushi restaurants are displayed on the road map, if the user touches the button 31 of the navigation function, it is judged that an operation for deactivation of the sushi restaurant position display function, that is, an operation for setting the sushi restaurant position display function off has been performed. In this case, the “function M” indicates the sushi restaurant position display function. Further, when the user touches the OFF button of the headlight auto turn-on function in FIG. 5B, it is judged that an operation for stopping activation of the headlight auto turn-on function has been performed, that is, an operation for setting the headlight auto turn-on function off has been performed. In this case, the “function M” indicates the headlight auto turn-on function.

When at step 103, it is judged that an operation for deactivation of the function M, that is, an operating for setting the function M off has been performed by the user, the routine proceeds to step 104 where the function M is set off and the function M is deactivated. At this time, if the function M is the sushi restaurant position display function, display of the positions of sushi restaurants on the road map is stopped, and if the function M is the headlight auto turn-on function, the headlight auto turn-on function for making the headlights automatically turn on is deactivated. If the function M is set off, as shown in step 105, the function M is rendered off in display. At this time, the on/off display switch 46 for the function M shown in FIG. 6B is switched from “display on” to “display off” while the short cut setting button of the candidates of the function M shown in FIG. 7A etc. is switched from “display on” to “display off”. If the short cut button for the function M is displayed, the short cut button for the function M is switched from “display on” to “display off”. On the other hand, if, at step 103, it is judged that an operation for setting the function M off has not been performed by the user, the processing cycle is ended.

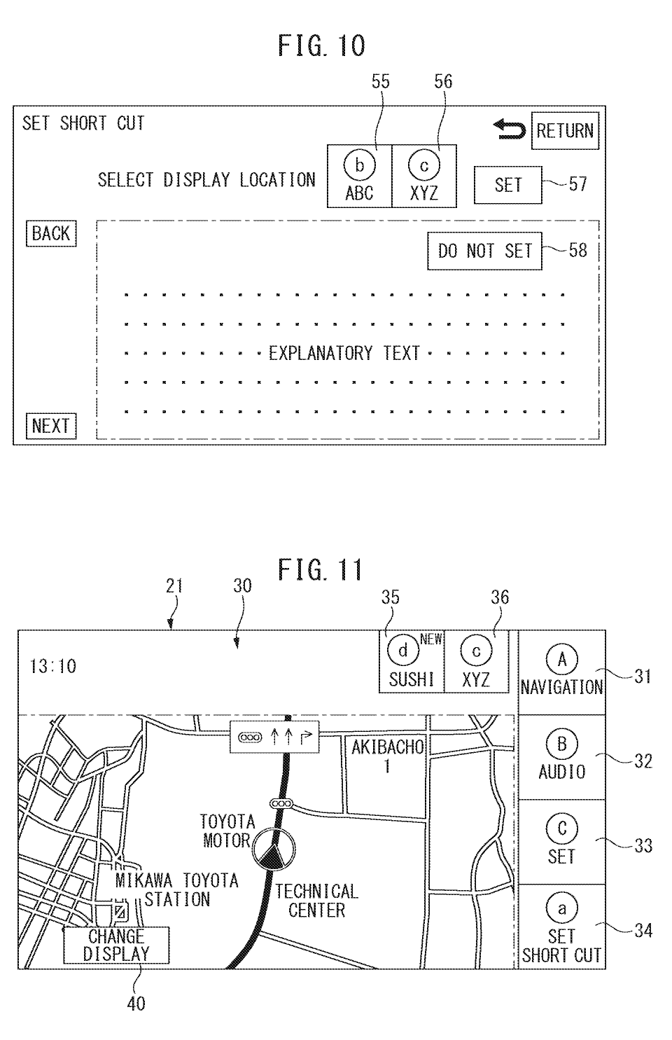

FIG. 13 shows a routine for performing processing for setting functions on/off by using the short cut buttons 35, 36. If explaining FIG. 10 with reference to the example of the case where the function M is assigned to one of the short cut buttons 35, 36, for example, the short cut button 35, first, at step 110, it is judged whether the short cut button 35 to which the function M has been assigned has been touched. When it is judged that the short cut button 35 has been touched, the routine proceeds to step 111 where it is judged whether currently the function M is set on, that is, whether the function M is activated. When it is judged that the function M is set off, that is, when it is judged that function M is deactivated, the routine proceeds to step 112.

At step 112, the function M is set on and the function M is activated. At this time, if the function M is the sushi restaurant position display function, the sushi restaurant position display function for displaying the positions of sushi restaurants on the road map is performed, while in the case where the function M is the headlight auto turn-on function, the headlight auto turn-on function for making the headlights automatically turn on is performed. If the function M is set on, as shown at step 113, the function M is rendered on in display. At this time, the short cut setting button of the candidates for the function M shown in FIG. 7A etc. is switched from “display off” to “display on”, the on/off display switch 46 of the function M shown in FIG. 6B is switched from “display off” to “display on”, and the short cut button 35 is switched from “display off” to “display on”.

On the other hand, when, at step 111, it is judged that the function M is currently set on, that is, the function M is activated, the routine proceeds to step 114 where the function M is set off and the function M is deactivated. At this time, if the function M is the sushi restaurant position display function, the display of the positions of sushi restaurants on the road map is stopped, while if the function M is the headlight auto turn-on function, the headlight auto turn-on function for making the headlights automatically turn on is deactivated.

If the function M is set off, as shown at step 115, the function M is rendered off in display. At this time, the short cut setting button of the candidates of the function M shown in FIG. 7A etc. is switched from “display on” to “display off”, the on/off display switch 46 of the function M shown in FIG. 6B is switched from “display on” to “display off”, and the short cut button 35 is switched from “display on” to “display off”. On the other hand, when at step 110, it is judged that the short cut button 35 has not been touched, the processing cycle is ended.

In this way, in an embodiment according to the present disclosure, the short cut buttons 35, 36 are displayed on the basic screen of the display device 21, and it is possible to set the functions respectively assigned to the short cut buttons 35, 36 on/off by just touching the short cut buttons 35, 36. Therefore, it is possible to lessen the burden felt by the user when setting the functions on/off. Here, the issue becomes which functions should be assigned to the short cut buttons 35, 36 to enable the burden felt by the user to be more effectively lessened. Therefore, next, the functions desirably assigned to the short cut buttons 35, 36 will be studied.

Now then, assume that, in the past, the restaurant selection screen shown in FIG. 5A was positioned at the lowest level. That is, assume that, in the past, if the Japanese food button 43 displayed on the restaurant selection screen shown in FIG. 5A was touched, the restaurant selection screen was switched to the road map screen shown in FIG. 3A and the positions of the Japanese restaurants were displayed on the road map. Further, assume that, when in such a state, the position display functions enabling display of positions of Japanese restaurants classified more finely in accordance with the type of Japanese food, that is, a sushi restaurant position display function able to display the positions of sushi restaurants on the road map, a tempura restaurant position display function able to display the positions of tempura restaurants on the road map, and a soba restaurant position display function able to display the positions of soba restaurants on the road map were developed and a selection screen relating to these functions shown in FIG. 5B was prepared.

In this case, in an embodiment according to the present disclosure, information relating to the selection screen shown in FIG. 5B and information relating to these sushi restaurant position display function, tempura restaurant position display function, and soba restaurant position display function and including a program for performing these functions are emitted as addition information of new functions or update information of existing functions from an information center. The information emitted from the information center is received by the vehicles 1. At this time, if the user of the vehicle 1 wishes to actively use these added new functions or updated existing functions, it may be considered to assign these added new functions or updated existing functions to either of the short cut buttons 35, 36.

That is to say, if assigning these added new function or updated existing function to for example the short cut button 35, by just touching the short cut button 35, it becomes possible to switch the added new function or updated existing function from the off setting to the on setting or from the on setting to the off setting and therefore becomes possible to lessen the burden felt by the user. Note that once the added new function or updated existing function is assigned to the short cut button 35, after that, the added new function or updated existing function is automatically assigned to the short cut button 35 each time the power of the vehicle 1 is turned on. Therefore, each time the power of the vehicle 1 is turned on, by just touching the short cut button 35, the added new function or updated existing function can be switched from the off setting to the on setting or can be switched from the on setting to the off setting.

In this way, once the added new function or updated existing function is assigned to the short cut button 35, after that it is possible to lessen the burden felt by the user. In this case, the user feels burdened when first assigning the added new function or updated existing function to the short cut button 35. When the added new function or updated existing function is first assigned to the short cut button 35, as explained above, the short cut setting button 34 displayed on the basic screen of the display device 21 is touched. Next, among the large number of the candidates of functions listed on the short cut setting screen shown in FIG. 7A, the short cut setting button of the function which the user desires to be assigned to the short cut button 35, for example, the short cut setting button 50 of the sushi restaurant position function which is one of the added new functions or updated existing functions is touched.

If the user touches the short cut setting button 50 of the sushi restaurant position display function which is one of the added new functions or updated existing functions on the short cut setting screen shown in FIG. 7A, as shown in FIG. 10, an explanatory text relating to the added new function or updated existing function, that is, an explanatory text relating to the sushi restaurant position display function is displayed on the short cut setting screen. In this case, the explanation regarding the added new function or updated existing function may be provided by voice. Therefore, speaking overall, if the user touches the short cut setting button 50 of one of the added new functions or updated existing functions on the short cut setting screen, an explanation is given relating to the added new function or updated existing function.

Next, for example, if the displayed location selection button 55 is touched then the setting button 57 is touched, the sushi restaurant position display function is assigned to the short cut button 35. That is, as shown in FIG. 11, an icon and text showing the sushi restaurant position display function are displayed at the short cut button 35 such as shown in FIG. 11. On the other hand, when the user decides not to assign the sushi restaurant position display function to the short cut button 35 from the explanation relating to the added new function or updated existing function, the user touches the “DO NOT SET” button 58 shown in FIG. 10. If the “DO NOT SET” button 58 shown in FIG. 10 is touched, at least one of the position of display and form of display of the sushi restaurant position display function is changed. This will be explained later.

In this regard, to lessen the burden felt by the user when assigning the added new functions or updated existing functions to the short cut buttons 35, 36, it is desirable that the added new functions or updated existing functions are selected preferentially from among all of the functions and displayed on the short cut setting screen so that the user can easily select the added new functions or updated existing functions desired to be assigned to the short cut buttons 35, 36. Further, when the added new functions or updated existing functions are displayed on the short cut setting screen, it is desirable that the added new functions or updated existing functions are displayed in a form enabling their display to be more easily found than display of not updated existing functions. Therefore, in an embodiment according to the present disclosure, provision is made of a function assigning unit for making a plurality of the candidates of functions to be assigned to the short cut buttons 35, 36 be displayed on the function selection screen of the display device 21, that is, the short cut setting screen shown in FIG. 7A and FIG. 7B and making the user select the functions to be assigned to the short cut buttons 35, 36. The added new functions or updated existing functions are preferentially selected as the candidates of functions and made to be displayed on the function selection screen, that is, the short cut setting screen shown in FIG. 7A and FIG. 7B. Note that in this case, the electronic control unit 13 forms this function assigning unit.

As explained above, in an embodiment according to the present disclosure, when the new function is completed or when the update program for the existing function is completed, information relating to these functions is emitted as addition information of the new function or update information of the existing function from for example an information center. The addition information of the new function or update information of the existing function emitted from the information center is received by each vehicle 1.

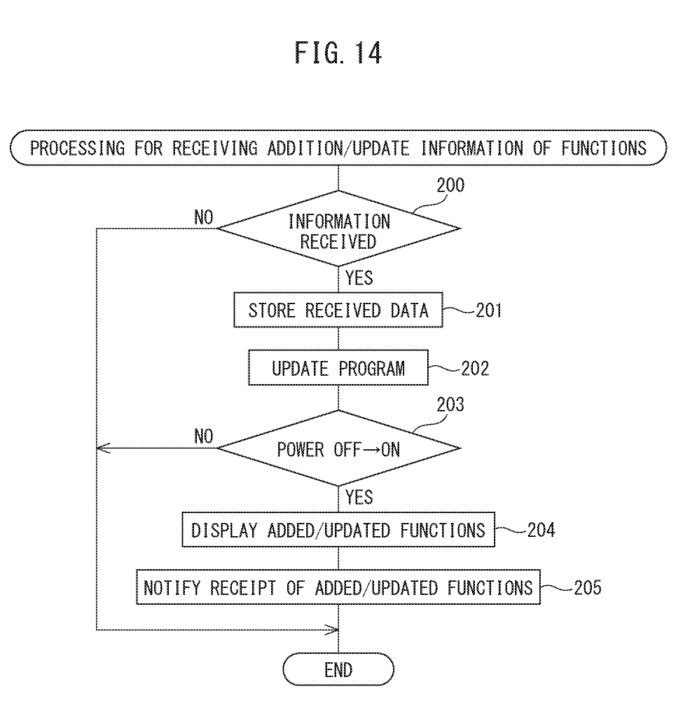

FIG. 14 shows the routine for performing processing for receiving such addition/update information of functions. This routine is repeatedly performed in the electronic control unit 13 of each vehicle 1.

Referring to FIG. 14, first, at step 200, it is judged whether addition information of the new function or update information of the existing function emitted from the information center has been received. When it is judged that such information has not been received, the processing cycle is ended. As opposed to this, when it is judged that such information has been received, the routine proceeds to step 201 where the received data relating to such information is stored in the memory 16 in the electronic control unit 13. Next, at step 202, the program stored in the memory 16 is updated based on the received data. Next, at step 203, it is judged whether the power of the vehicle 1 is switched from off to on, that is, whether the power is turned on. When it is judged that the power is not turned on, the processing cycle is ended.

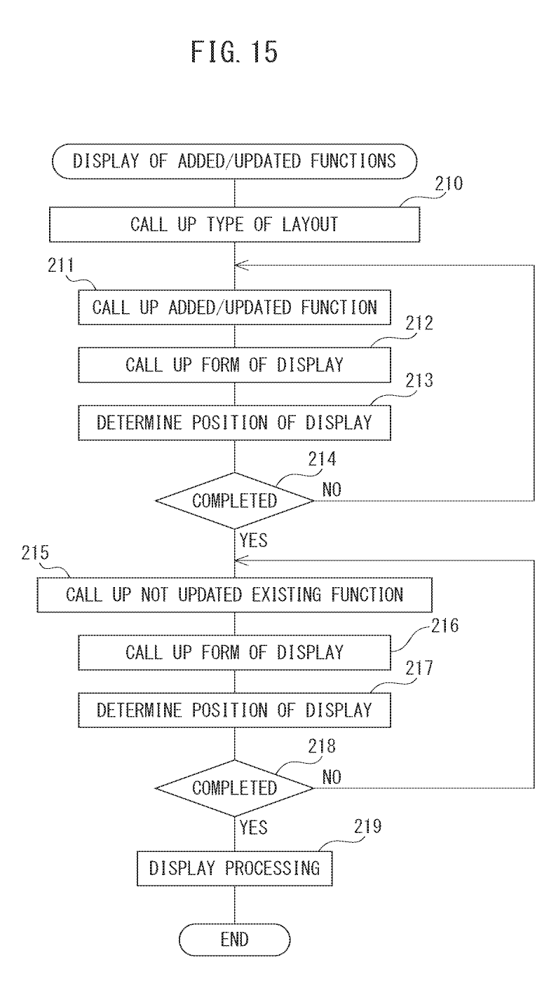

As opposed to this, when at step 203 it is judged that the power is turned on, the routine proceeds to step 204 where the processing for display of the added/updated function which makes the added/updated function be displayed as the candidates of functions on the function selection screen, that is, the short cut setting screen shown in FIG. 7A and FIG. 7B is performed. This processing for display of the added/updated function is shown in FIG. 15. Next, at step 205, the user of the vehicle 1 is notified that addition/update information has been received. This notification is performed by displaying the fact of the receipt of the added/updated function on the basic screen of the display device 21 at the time the power is turned on.

Next, the routine shown in FIG. 15 for performing the processing for display of the added/updated function at step 204 of FIG. 14 will be explained. This routine is performed inside the electronic control unit 13 of each vehicle 1.

Referring to FIG. 15, first, at step 210, the type of layout of listing of function candidates when listing the function candidates is called up from the memory 16 of the electronic control unit 13. This type of layout of listing of function candidates is stored in the memory 16 of the electronic control unit 13 in advance.

Next, at step 211, one added new function or updated existing function is called up from the memory 16 of the electronic control unit 13. Next, at step 212, the form of display for that called up one function is called up from the memory 16 of the electronic control unit 13. Note that the form of display of the added new function or updated existing function, that is, display of the function by text, display of the function by an icon, and the size of the text or icon, is stored in the memory 16 of the electronic control unit 13. Next, at step 213, the position of display of the added new function or updated existing function at the layout of listing of function candidates is determined. Next, at step 214, it is judged if all of the added new functions or updated existing functions have finished being called up. When it is judged that all of the added new functions or updated existing functions have not finished being called up, the routine returns to step 211. The form of display and the position of display are determined for all of the added new functions or updated existing functions in this way.

When at step 214 it is judged that all of the added new functions or updated existing functions have finished being called up, the routine proceeds to step 215, where one of not updated existing functions is called up from the memory 16 of the electronic control unit 13. Next, at step 216, the form of display of the called up not updated existing function is called up from the memory 16 of the electronic control unit 13. Note that the form of display of the not updated existing function, that is, the display of the function by text, display of the function by an icon, and the size of the text or icon, is stored in the memory 16 of the electronic control unit 13. Next, at step 217 the position of display of the not updated existing function in the layout of listing of function candidates is determined. Next, at step 218, it is judged whether a preset number of not updated existing functions or a number of not updated existing functions which falls inside have finished being called up. When it is judged that a preset number of not updated existing functions or a number of not updated existing functions which falls inside the layout of listing of function candidates have not finished being called up, the routine returns to step 215. The forms of display and positions of display are determined for a preset number of not updated existing functions or a number of not updated existing functions which falls inside the layout of listing of function candidates in this way.

When at step 218 it is judged that a preset number of not updated existing functions or a number of not updated existing functions which falls inside the layout of listing of function candidates have finished being called up, the routine proceeds to step 219 where the determined forms of display and positions of display are used to display the added new functions or updated existing functions and not updated existing functions as candidates of functions on the function selection screen of the display device 21, that is, the short cut setting screen shown in FIG. 7A and FIG. 7B. In this way, in an embodiment of the present disclosure, the added new functions or updated existing functions are preferentially selected as candidates of functions. As a result, the added new functions or updated existing functions are preferentially displayed as candidates of functions on the function selection screen of the display device 21, that is, the short cut setting screen shown in FIG. 7A and FIG. 7B.

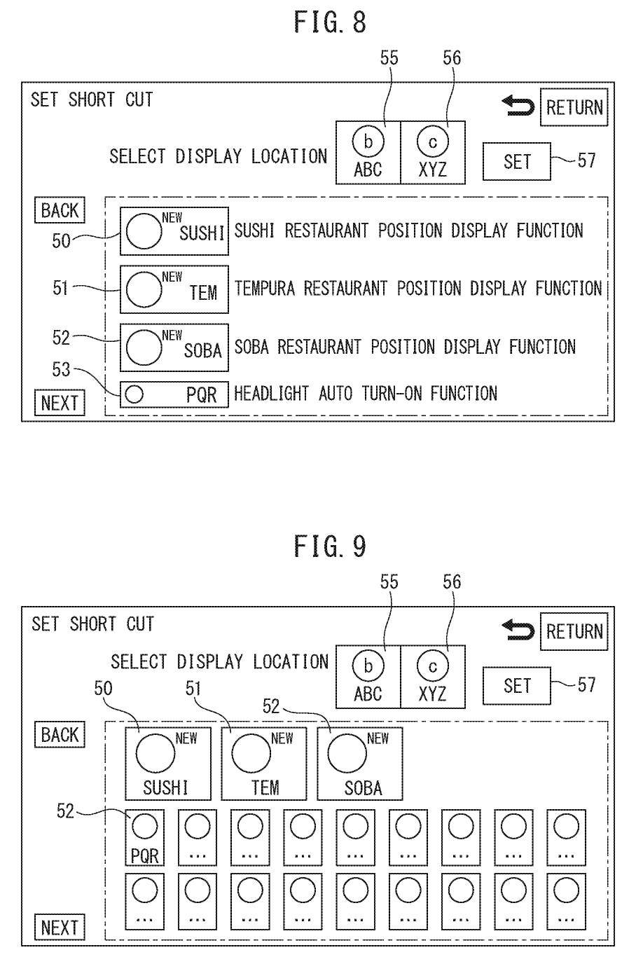

FIG. 7A, FIG. 8, and FIG. 9 show several examples of forms of display of the added new functions or updated existing functions and not updated existing functions. In the example shown in FIG. 7A, a large number of the functions are displayed on the short cut setting screen, that is, the function selection screen, divided into pages. To make it easier for the user to select the added new functions or updated existing functions which the user wishes to assign to the short cut buttons 35, 36, for example, the sushi restaurant position display function, the tempura restaurant position display function, and the soba restaurant position display function, the sushi restaurant position display function, the tempura restaurant position display function, and the soba restaurant position display function, that is, the added new functions or updated existing functions are displayed on the first page.

On the other hand, in the example shown in FIG. 8, icons of the functions are displayed on the short cut setting screen, that is, the function selection screen. To make it easier for the user to select the added new functions or updated existing functions which the user wishes to assign to the short cut buttons 35, 36, for example, the sushi restaurant position display function, the tempura restaurant position display function, and the soba restaurant position display function, the icons of the sushi restaurant position display function, the tempura restaurant position display function, and the soba restaurant position display function, that is, the icons of the added new functions or updated existing functions are displayed larger than the icons of not updated existing functions, for example, the headlight auto turn-on function.

Further, in the example shown in FIG. 9, pluralities of icons of the functions are displayed on the short cut setting screen, that is, the function selection screen, aligned vertically and horizontally. To make it easier for the user to select the added new functions or updated existing functions which the user wishes to assign to the short cut buttons 35, 36, for example, the sushi restaurant position display function, the tempura restaurant position display function, and the soba restaurant position display function, the icons of the sushi restaurant position display function, the tempura restaurant position display function and the soba restaurant position display function, that is, the icons of the added new functions or updated existing functions are displayed at the topmost row.

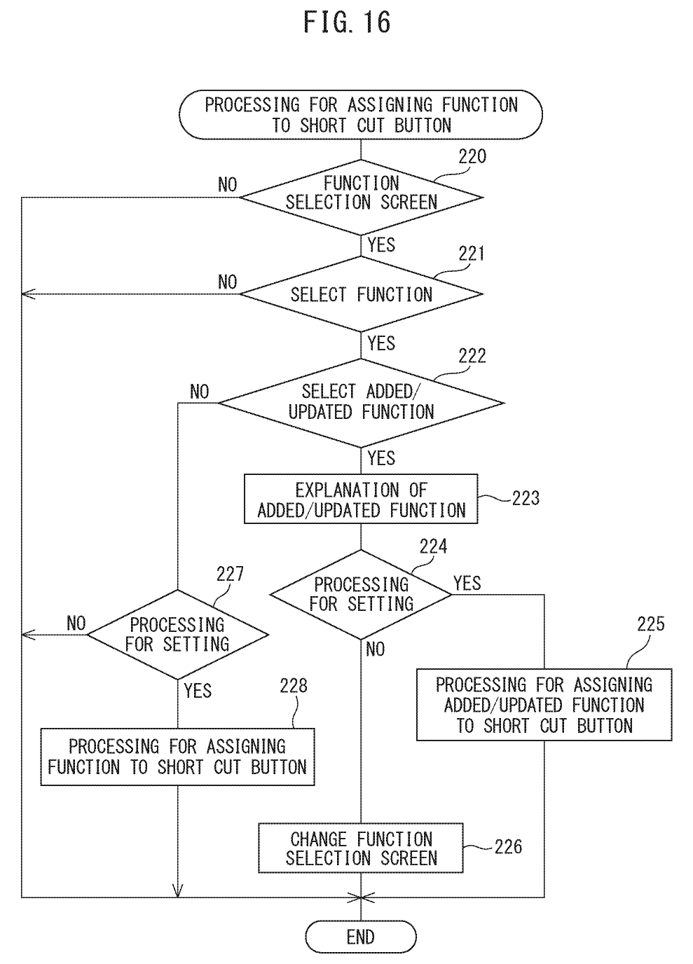

FIG. 16 shows the routine for performing processing for assigning functions to the short cut buttons 35, 36. This routine is repeatedly performed in the electronic control unit 13.

Referring to FIG. 16, first, at step 220, it is judged whether the screen of the display device 21 is the function selection screen, that is, the short cut setting screen shown in FIG. 7A and FIG. 7B. When it is judged that the screen of the display device 21 is not the function selection screen, the processing cycle ends. As opposed to this, when it is judged that the screen of the display device 21 is the function selection screen, the routine proceeds to step 221 where it is judged if the functions desired to be assigned to the short cut buttons 35, 36 have been selected on the function selection screen. When it is judged that the functions desired to be assigned to the short cut buttons 35, 36 have not been selected, the processing cycle ends.

As opposed to this, when it is judged that the functions desired to be assigned to the short cut buttons 35, 36 have been selected, the routine proceeds to step 222 where it is judged whether the added new functions or updated existing functions, for example, the sushi restaurant position display function, the tempura restaurant position display function and the soba restaurant position display function have been selected as functions which the user wishes to assign to the short cut buttons 35, 36. When it is judged that added new functions or updated existing functions have been selected as functions desired to be assigned to the short cut buttons 35, 36, the routine proceeds to step 223 where explanations are given of the added new functions or updated existing functions. At this time, for example, as shown in FIG. 10, the explanatory texts regarding the added new functions or updated existing functions are displayed on the short cut setting screen.

Next, at step 224, it is judged whether, on the short cut setting screen, the displayed location selection button 55 has been touched and then the setting button 57 has been touched, that is, whether the a setting processing for assigning the explained functions (the added new functions or updated existing functions) to the short cut buttons 35, 36 has been performed. When it is judged that the setting processing has been performed, the routine proceeds to step 225 where the explained functions (the added new functions or updated existing functions) are assigned to the short cut buttons 35, 36. Due to this, as shown in FIG. 11, the short cut button 35 for the explained function (the added new function or updated existing function) is displayed on the basic screen of the display device 21.

On the other hand, when at step 224 it is judged that the “DO NOT SET” button 58 on the short cut setting screen shown in FIG. 10 has been touched, that is, when it is judged that the setting processing for assigning the explained functions (the added new functions or updated existing functions) to the short cut buttons 35, 36 has not been performed, the routine proceeds to step 226 where at least one of the positions of display and forms of display of the explained functions (the added new functions or updated existing functions) on the short cut setting screen is changed. For example, if the explained function (the added new function or updated existing function) was the sushi restaurant position display function, in the example shown in FIG. 7A, the position of display of the sushi restaurant position display function is changed to the rear, in the example shown in FIG. 8, the icon and text showing the sushi restaurant position display function are made smaller down to the same size as the icon and text showing the headlight auto turn-on function and the position of display of the sushi restaurant position display function is changed to the rear, and in the example shown in FIG. 9, the icon and text showing the sushi restaurant position display function are made smaller down to the same size as the icon and text showing the headlight auto turn-on function and the position of display of the sushi restaurant position display function is changed to the second row or further down. That is, if the user did not select the added new function or updated existing function from among the candidates of functions, the form of display of the added new function or updated existing function is changed to a form the same as the form of display of the not updated existing functions.

On the other hand, when, at step 222, it is judged that the added new functions or updated existing functions are not selected as functions desired to be assigned to the short cut buttons 35, 36, that is, when it is judged that the not updated existing functions are selected as the functions desired to be assigned to the short cut buttons 35, 36, the routine proceeds to step 227 where it is judged whether, on the short cut setting screen, the displayed location selection button 55 has been touched and then the setting button 57 has been touched, that is, whether the setting processing for assigning the not updated existing functions to the short cut buttons 35, 36 has been performed. When it is judged that this setting processing has been performed, the routine proceeds to step 228 where the not updated existing functions are assigned to the short cut buttons 35, 36. In this case, the short cut button 35 for the not updated existing function is displayed on the basic screen of the display device 21. Note that, when, at step 227, it is judged that setting processing for assigning the not updated existing functions to the short cut buttons 35, 36 has not been performed, the processing cycle is ended.

In this way, in an embodiment of the present disclosure, in a display control device for controlling the screen display of the display device 21 mounted in the vehicle 1, the display control device comprises a short cut button display control unit for making the short cut buttons 35, 36 be displayed on the basic screen of the display device 21 and a function assigning unit for making a plurality of candidates for functions to be assigned to the short cut buttons 35, 36 be displayed on the function selection screen of the display device 21 and making a user select functions to be assigned to the short cut buttons 35, 36. The function assigning unit makes the added new functions or updated existing functions be preferentially displayed as the candidates of functions on the function selection screen when acquiring addition information of the new functions or update information of the existing functions.

Further, in an embodiment of the present disclosure, there is provided a display control method for controlling the screen display of the display device 21 mounted in the vehicle 1, the display control method causing a computer to make the short cut buttons 35, 36 be displayed on the basic screen of the display device 21, make a plurality of candidates for functions to be assigned to the short cut buttons 35, 36 be displayed on the function selection screen of the display device 21 and make a user select functions to be assigned to the short cut buttons 35, 36, and, make added the new functions or updated existing functions be preferentially displayed as the candidates of functions on the function selection screen when acquiring addition information of the new functions or update information of the existing functions.

Further, in an embodiment of the present disclosure, there is provided a program or a program product used for controlling the screen display of the display device 21 mounted in the vehicle 1, the program or the program product causing a computer to make the short cut buttons 35, 36 be displayed on the basic screen of the display device 1, make a plurality of candidates for functions to be assigned to the short cut buttons 35, 36 be displayed on the function selection screen of the display device 21 and make a user select functions to be assigned to the short cut buttons 35, 36, and, make the added new functions or updated existing functions be preferentially displayed as the candidates of functions on the function selection screen when acquiring addition information of the new functions or update information of the existing functions.

Further, in an embodiment of the present disclosure, the function assigning unit makes the added new functions or the updated existing functions be displayed on the function selection screen in a form enabling the user to easily find display of the added new functions or the updated existing functions compared with display of not updated existing functions so that the user can easily select the added new functions or the updated existing functions from among the candidates of functions. In this case, when the user does not select the added new functions or the updated existing functions from among the candidates of the functions, the function assigning unit changes the form of display of the added new functions or the updated existing functions to the same form as the form of display of the not updated existing functions.

Further, in an embodiment of the present disclosure, the function assigning unit makes the candidates of the functions be displayed on the function selection screen divided into a plurality of pages and makes the added new functions or the updated existing functions be displayed on a first page. Further, in an embodiment of the present disclosure, the function assigning unit makes icons of the candidates of the functions be displayed on the function selection screen and makes the icons of the added new functions or the updated existing functions be displayed larger than the icons of the not updated existing functions. Further, in an embodiment of the present disclosure, the function assigning unit makes a plurality of icons of the candidates of functions be displayed on the function selection screen aligned vertically and horizontally and makes the icons of the added new functions or the updated existing functions be displayed at a topmost row.

Further, in an embodiment of the present disclosure, when the added new functions or the updated existing functions are selected by the user from among the candidates of functions displayed on the function selecting screen, the explanation regarding an overview of the added new functions or the updated existing functions is performed. Further, in an embodiment of the present disclosure, the short cut buttons 35, 36 are formed so that the functions assigned to the short cut buttons 35, 36 are switched between being set on and being set off each time the short cut buttons 35, 36 are touched.

1. A display control device for controlling a screen display of a display device mounted in a vehicle, the display control device comprising:
a short cut button display control unit for making short cut buttons be displayed on a basic screen of the display device and
a function assigning unit for making a plurality of candidates for functions to be assigned to the short cut buttons be displayed on a function selection screen of the display device and making a user select functions to be assigned to the short cut buttons,
said function assigning unit making added new functions or updated existing functions be preferentially displayed as the candidates of functions on the function selection screen when acquiring addition information of the new functions or update information of the existing functions.

2. The display control device according to claim 1, wherein the function assigning unit makes the added new functions or the updated existing functions be displayed on the function selection screen in a form enabling the user to easily find display of the added new functions or the updated existing functions compared with display of not updated existing functions so that the user can easily select the added new functions or the updated existing functions from among the candidates of functions.

3. The display control device according to claim 2, wherein when the user does not select the added new functions or the updated existing functions from among the candidates of the functions, the function assigning unit changes the form of display of the added new functions or the updated existing functions to the same form as the form of display of the not updated existing functions.

4. The display control device according to claim 1, wherein the function assigning unit makes the candidates of the functions be displayed on the function selection screen divided into a plurality of pages and makes the added new functions or the updated existing functions be displayed on a first page.

5. The display control device according to claim 1, wherein the function assigning unit makes icons of the candidates of the functions be displayed on the function selection screen and makes the icons of the added new functions or the updated existing functions be displayed larger than the icons of not updated existing functions.

6. The display control device according to claim 1, wherein the function assigning unit makes a plurality of icons of the candidates of functions be displayed on the function selection screen aligned vertically and horizontally and makes the icons of the added new functions or the updated existing functions be displayed at a topmost row.

7. The display control device according to claim 1, wherein when the added new functions or the updated existing functions are selected by the user from among the candidates of functions displayed on the function selecting screen, the explanation regarding an overview of the added new functions or the updated existing functions is performed.

8. The display control device according to claim 1, wherein the short cut buttons are formed so that the functions assigned to the short cut buttons are switched between being set on and being set off each time the short cut buttons are touched.

9. A display control method for controlling a screen display of a display device mounted in a vehicle, the display control method causing a computer to
make short cut buttons be displayed on a basic screen of the display device,
make a plurality of candidates for functions to be assigned to the short cut buttons be displayed on a function selection screen of the display device and make a user select functions to be assigned to the short cut buttons, and,
make added new functions or updated existing functions be preferentially displayed as the candidates of functions on the function selection screen when acquiring addition information of the new functions or update information of the existing functions.

10. A non-transitory computer-readable storage medium storing a program used for controlling a screen display of a display device mounted in a vehicle, the program causing a computer to
make short cut buttons be displayed on a basic screen of the display device,
make a plurality of candidates for functions to be assigned to the short cut buttons be displayed on a function selection screen of the display device and make a user select functions to be assigned to the short cut buttons, and,
make added new functions or updated existing functions be preferentially displayed as the candidates of functions on the function selection screen when acquiring addition information of the new functions or update information of the existing functions.
